(19) United States
(12) Patent Application Publication
(10) Pub. No.: US 2017/0124367 A1
(43) Pub. Date: May 4, 2017

(54) ALIGNMENT MARKERS TO FACILITATE DETECTION OF OBJECT ORIENTATION AND DEFORMATION

(71) Applicant: EMPIRE TECHNOLOGY DEVELOPMENT LLC, Wilmington, DE (US)

(72) Inventors: Mordehai Margalit, ZICHRON YAAQOV (IL); Youval Nehmadi, NILI (IL)

(21) Appl. No.: 14/926,006

(22) Filed: Oct. 29, 2015

(51) Int. Cl. G06K 7/10; G06K 9/62; G06K 7/14

(52) U.S. Cl. CPC G06K 7/10722; G06K 7/1413; G06K 7/1417; G06K 9/6217; G06K 2209/01

(57) ABSTRACT

Technologies are generally described for use of orientation markers to determine object orientation and/or deformation. In some examples, an orientation marker for a physical object may include an alignment structure and encode information about the alignment structure. For example, the orientation marker may encode the size of the alignment structure, the orientation of the alignment structure, and the location of the alignment structure with respect to some physical point on the physical object and/or other orientation markers on the physical object An orientation system may then use the encoded information to determine the orientation and/or alignment of the object. The orientation system may also use the encoded information to determine whether the physical object is deformed.

### BACKGROUND

Unless otherwise indicated herein, the materials described in this section are not prior art to the claims in this application and are not admitted to be prior art by inclusion in this section.

Use of robotic manipulation and machine vision are becoming more widespread in industries such as manufacturing, shipping, and food production, among others. In manufacturing environments where robotic assembly or manipulation of physical items occurs, robots may need information about the position and/or the orientation of an object in order to properly handle the object.

### SUMMARY

The present disclosure generally describes techniques for detecting object orientation and deformation.

According to some examples, an orientation marker is provided to allow detection of object orientation and deformation. The orientation marker may include an alignment structure, an alignment marker portion, and a location marker portion. The alignment marker portion may be configured to encode at least one dimensional data associated with the alignment structure. The location marker portion may be configured to encode at least one location data associated with the orientation marker.

According to other examples, a method is provided to determine orientation information for a physical object. The method may include receiving image data associated with an orientation marker on the physical object and determining, from the image data, an encoded dimensional data and/or an encoded location data, both associated with the orientation marker. The method may further include determining an orientation of the physical object based on the encoded dimensional data and/or the encoded location data.

According to further examples, a system is provided, to determine orientation information for a physical object. The system may include an imager and a processor block. The imager may be configured to receive image data associated with an orientation marker on the physical object. The processor block may be configured to determine, from the image data, an encoded dimensional data and/or an encoded location data, both associated with the orientation marker. The processor block may be further configured to determine an orientation of the physical object based on the encoded dimensional data and/or the encoded location data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying, drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system where orientation markers on physical objects may be used;

FIG. 2 illustrates examples of orientation markers that encode location and/or dimensional information;

FIG. 3 illustrates how distances between orientation markers on an object may be used to detect object deformation;

FIG. 4 illustrates examples of orientation markers that encode references to external data storage;

FIG. 5 illustrates a general purpose computing device, which may be used to determine object orientation and/or deformation;

FIG. 6 is a flow diagram illustrating an example method to determine object orientation and/or deformation that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to determination of object orientation and/or deformation.

Briefly stated, technologies are generally described for use of orientation markers to determine object orientation and/or deformation. In some examples, an orientation marker for a physical object may include an alignment structure and encode information about the alignment structure. For example, the orientation marker may encode the size of the alignment structure, the orientation of the alignment structure, and the location of the alignment structure with respect to some physical point on the physical object and/or other orientation markers on the physical object. An orientation system may then use the encoded information to determine the orientation and/or alignment of the object. The orientation system may also use the encoded information to determine whether the physical object is deformed.

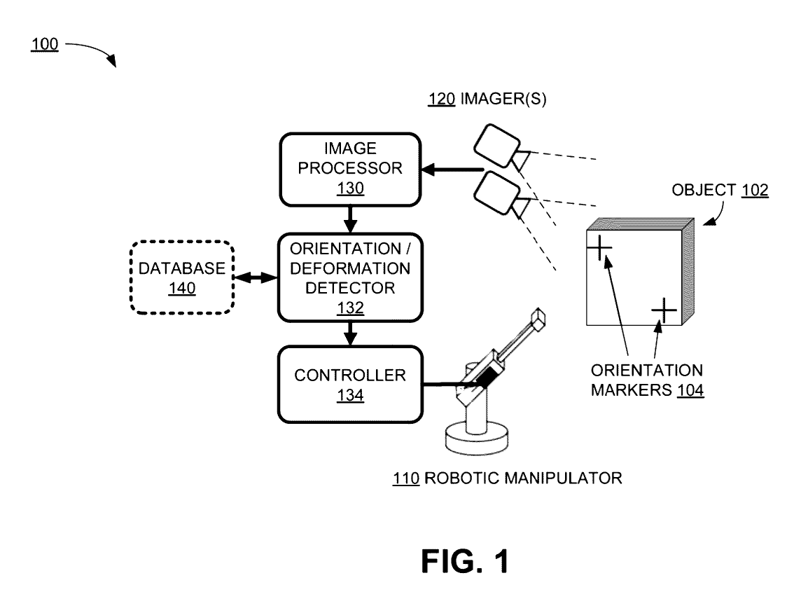

FIG. 1 illustrates an example system 100, where orientation markers on physical objects may be used, arranged in accordance with at least some embodiments described herein.

The system 100 may include a robotic manipulator 110 configured to manipulate a physical object 102 having one or more orientation markers 104. The orientation markers 104 may encode orientation, location, and/or deformation information about the object 102, and in some embodiments may be imprinted, printed, embossed, and/or painted on the object 102, for example during, manufacture of the object 102 or at some subsequent time. The orientation markers 104 may be placed at any suitable location on the object 102, that is, on the object's surface. For multi-faceted objects, the orientation markers 104 may be distributed on different facets of the object to ensure detection by image capture devices.

In some embodiments, the robotic manipulator 110 may be stationary with a movable arm/manipulator, or may be an autonomous mobile robot. A controller 134 may cause the robotic manipulator 110 to perform physical actions such as assembling objects, moving objects between different containers, conveyances, and areas, or any other suitable physical task. For example, the controller 134 may be configured to execute operations in one or more programs to cause the robotic manipulator 110 to perform individual movements or series of movements. The controller 134 may also (or instead) execute operations in program(s) received via an external network interface from, for example, an external controller.

In some embodiments, the controller 134 may control the robotic manipulator 110 based on sensor inputs associated with the robotic manipulator 110 and/or the object 102. For example, one or more imager(s) 120 may be configured to detect and/or record data regarding or associated with the robotic manipulator 110, the object 102, and/or one or more orientation markers 104 present on the object 102. The imagers 120 may be cameras configured to detect optical data (for example, visible light images), infrared data, or any other suitable data. The imagers 120 may send the data to an image processor 130, which may attempt to extract information of interest front the received data. For example, the image processor 130 may attempt to identify the object 102, identify an orientation of the robotic manipulator 110, identify the orientation markers 104, and/or identify any other suitable features of interest.

The image processor 130 may then provide the extracted information to an orientation/deformation detector 132. The orientation/deformation detector 132 may be configured to determine one or more physical features associated with the object 102. For example, as described above, the orientation markers 104 may encode orientation, location, and/or deformation information about the object 102. The detector 132 may then use information about the orientation markers 104 received from the image processor 130 to determine an orientation of the object 102, and/or may attempt to determine whether the object 102 is deformed in any way. In some embodiments, the orientation/deformation detector 132 may also be coupled to a database 140, and may determine the orientation and/or deformation of the object 102 based on the orientation markers 104 and information retrieved, from the database 140. The orientation/deformation detector 132 may then provide the determined orientation and/or deformation information to the controller 134, which may use the information to guide the movements of the robotic manipulator 110.

As described above, orientation markers such as the orientation markers 104 may encode orientation, location, and/or deformation information about a physical object such as the object 102. Orientation markers may encode the information about the physical object in a number of ways.

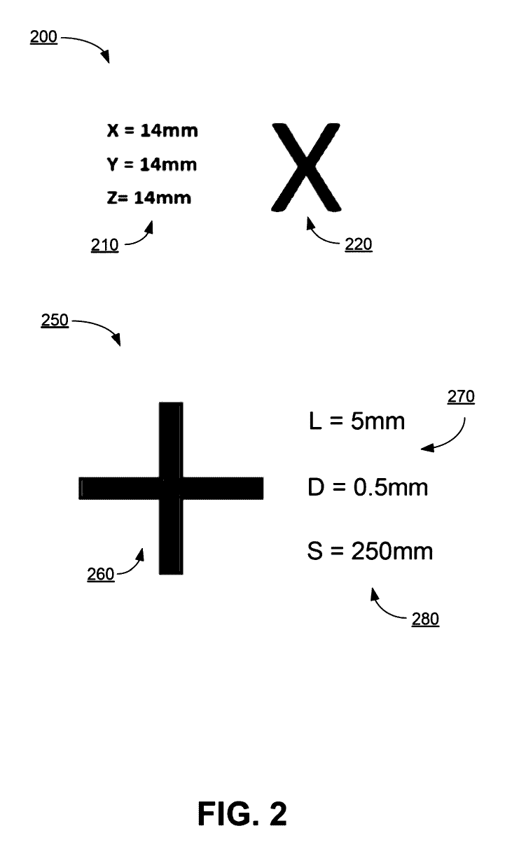

FIG. 2 illustrates examples of orientation markers that encode location and/or dimensional information, arranged in accordance with at least some embodiments described herein.

A first orientation marker 200 that may be disposed on a physical object such as the object 102 may include a location marker portion 210 and an alignment structure 220. Both the location marker portion 210 and the alignment structure 220 may encode information about the first orientation marker 200. For example, the location marker portion 210 may encode location information that identifies where the first orientation marker 200 is located on the object. In some embodiments, the location marker portion 210 may encode the location information in a human-readable format, as depicted in FIG. 2, and an orientation system may use optical character recognition to extract the encoded information. The location marker portion 210 may encode the location information in absolute terms, relative to a fixed physical origin or point on the object. In some embodiments, the location marker portion 210 may also (or instead) encode the location of at least one other orientation marker on the physical object. In these embodiments, the location marker portion 210 may encode the location information in absolute terms and/or relative to the location of the first orientation marker 200.

The alignment structure 220 may be configured to provide orientation information with respect to the physical object. For example, the alignment structure 220 may be configured to indicate one or more coordinate axes which, in combination with the location information encoded in the location marker portion 210, allow the first orientation marker 200 and/or other orientation markers to be located.

A second orientation marker 250 that may be disposed on a physical object may include an alignment structure 260, an alignment marker portion 270, and a location marker portion 280. The alignment structure 260 may be similar to the alignment structure 220. The alignment marker portion 270 may encode dimension and/or size parameters for the second orientation marker 250 and/or the alignment structure 260. For example, the alignment marker portion 270 may encode a length associated with the alignment structure 260 (for example, a length of a portion of the entire alignment structure 260 or a length of an arm of the depicted alignment structure 260). The alignment marker portion 270 may also encode a diameter or width associated with the alignment structure 260 (for example, a width of the entire alignment structure portion or a width of an arm of the depicted alignment structure 260). In some embodiments, the alignment marker portion 270 may encode a size parameter associated with the entire second orientation marker 250 and/or the alignment structure 260.

In some embodiments, the alignment marker portion 270 may be used to calibrate orientation systems used to determine object orientation. For example, an orientation system such as the orientation/deformation detector 132 may be able to recover the dimension and/or size parameters encoded in the alignment marker portion 270. At the same time, the orientation system may be able to determine an actual dimension and/or size of the second orientation marker 250 and/or the alignment structure 260, for example via image data captured by imagers such as the imagers 120. The orientation system may then be able to compare the recovered dimension/size parameters with the actual, detected dimension/size to determine the distance between the imagers and the second orientation marker 250 and/or the alignment structure 260. Accordingly, this may enable the orientation system to orient the physical object in three-dimensional space, for example, when combined with corresponding measurements of other orientation markers on the object.

The comparison process described above may also be used to detect local deformation in the physical object. For example, assume that the object has been deformed such that part but not all of the second orientation marker 250 has been deformed. In this case, the orientation system may determine that some of the recovered dimension/size parameters associated with the second orientation marker 250 (for example, those parameters corresponding to the un-deformed portions of the second orientation marker 250) match the corresponding actual, detected dimensions/size. The orientation system may also determine that other recovered dimension/size parameters (for example, those corresponding to the deformed portions of the second orientation marker 250) do not match their corresponding actual, detected dimensions/size. The orientation system may then be able to use this information to identify local deformation of the object around the second orientation marker 250.

The location marker portion 280 may be similar to the location marker portion 210. However, in some embodiments the location marker portion 280 may also (or instead) encode a distance from the second orientation marker 250 (or the alignment structure 260) to another physical point associated with the object. For example, the location marker portion 280 may encode a distance from the second orientation marker 250 to a fixed physical origin, a particular physical point on the object, and/or one or more other orientation markers on the object. In some embodiments, the location marker portion 280 may encode a sum of distances to multiple other orientation markers on the object. For example, the location marker portion 280 may encode a sum of the distances to all other orientation markers on the object in some embodiments, these distances may be used to identify deformation of the object an a relatively large scale, as described below.

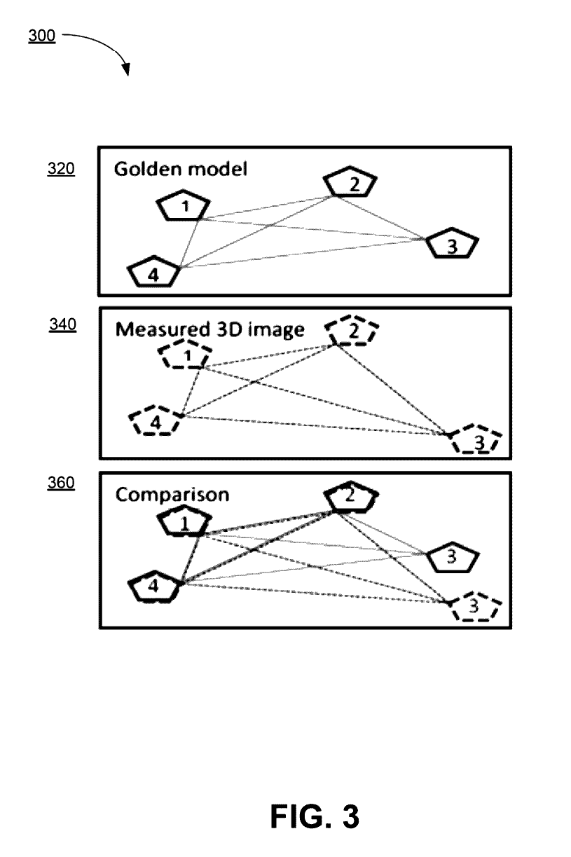

FIG. 3 illustrates how distances between orientation markers on an object may be used to detect object deformation, arranged in accordance with at least some embodiments described herein.

According to a diagram 300, a physical object may include multiple orientation markers, denoted as markers 1, 2, 3, and 4 in the diagram 300. A “golden model” of the markers 1-4 is shown in a diagram 320, which may represents the relative positions of the markers 1-4 to each other at an initial time (for example, when the markers were first incorporated into the object). In the golden model, each of the markers 1-4 is separated from every other marker by a particular distance, which may vary depending on the particular markers. These distances, individually or as a sum, may then be encoded into the orientation markers, as described above.

Supposing that the object is deformed at some point, for example due to a manufacturing defect or subsequent mishandling. This may cause one or more of the markers 1-4 to Shift in position with respect to the other markers. For example, suppose the deformation caused the marker 3 to shift in position with respect to the markets 1, 2, and 4. An orientation system may subsequently capture image data, depicted in a diagram 340, of the deformed object. The orientation system may then attempt to determine whether deformation of the object has occurred, by comparing the distances encoded into the markers 1-4 with the actual, observed distances, depicted in a diagram 360. In some embodiments, the orientation system may determine deformation by determining a distance change parameter between two markers i and j:

DC12_{i,j}=|\sqrt{(X1ᵢ−X1ⱼ)²+(Y1ᵢ−Yⱼ)²+(Z1ᵢ−Z1ⱼ)²}−\sqrt{(X2ᵢ−X2ⱼ)²+(Y2ᵢ−Y2ⱼ)²+(Z2ᵢ−Z2ⱼ)²}|, [1]

where X1ᵢ, Y1ᵢ, and Z1ᵢ, may represent the three-dimensional coordinates of marker i in the golden model, X1ⱼ, Y1ⱼ, and Z1ⱼ may represent the coordinates of marker j in the golden model, X2ᵢ, Y2ᵢ, and Z2ᵢ may represent the coordinates of the observed marker i, and X2ⱼ, Y2ⱼ and Z2ⱼ may represent the coordinates of the observed marker j. If the distance change parameter between two markers is higher than a predefined threshold, for example, then the orientation system may determine that deformation has occurred.

In another embodiment, the orientation system may use a sum of distances to determine whether deformation has occurred. For example, the orientation system may determine the sum of distances from a particular marker j to all other markers:

Rank (j)=Σ_{i=1,i≠j}^{N}DC12_{i,j}=Σ_{i=1,i≠j}^{N}|\sqrt{(X1ᵢ−X1ⱼ)²+(Y1ⱼ−Y1ⱼ)²+(Z1ᵢ−Z1ⱼ)²}−\sqrt{(X2ᵢ−X2ⱼ)²+(Y2ᵢ−Y2ⱼ)²+(Z2ᵢ−Z2ⱼ)²}, [2]

where N may represent the number of other markers. This sum of distances, which may be referred to as a rank, may represent how deformed the object is near the vicinity of the marker j. For example, a marker that has a substantially higher rank than other markers may indicate deformation around that marker.

As described above, an orientation marker on a physical object may encode location, distance, dimension, and/or size information about the orientation marker and/or other orientation markers on the physical object. In some embodiments, an orientation marker may encode information as external references.

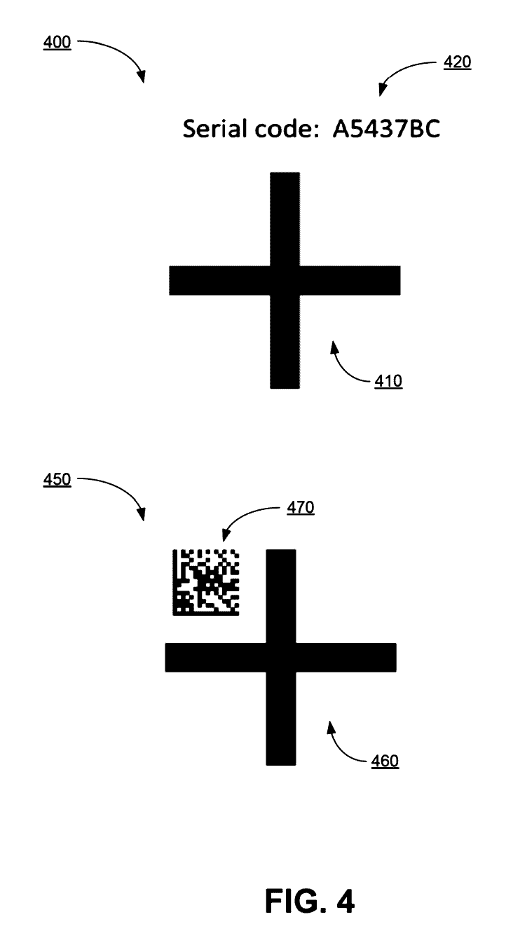

FIG. 4 illustrates examples of orientation markers that encode references to external data storage, arranged in accordance with at least some embodiments described herein.

An orientation marker 400 that may be disposed on a physical object may include an alignment structure 410, similar to the alignment structure 220, and may also include a marker code 420. The marker code 420 may include a reference to an external entity that stores or has access to the location, distance, dimension, and/or size information about the orientation marker 400. An orientation system, upon extracting the marker code 420 from captured image data using, for example, optical character recognition, may then be able to use the marker code 420 to identify the referenced external entity and/or retrieve the data associated with the orientation marker 400 from the referenced external entity. For example, the external entity may be a database such as the database 140, and the orientation system may use the marker code 420 to perform a database lookup to retrieve the data associated with the orientation marker 400.

In another embodiment, an orientation marker 450 that may be disposed on a physical object may include an alignment structure 460, similar to the alignment structure 410, and may also include a two-dimensional barcode 470. The barcode 470, similar to the marker code 420, may include a reference to an external entity that stores information about the orientation marker 450. An orientation system may then be able to extract a code from the barcode 470 and use the extracted code to retrieve the information associated with the orientation marker 450 from the external entity. In some embodiments, the barcode may also or instead itself store the marker information in a digitally-recognizable format, for example by encoding data in a binary format.

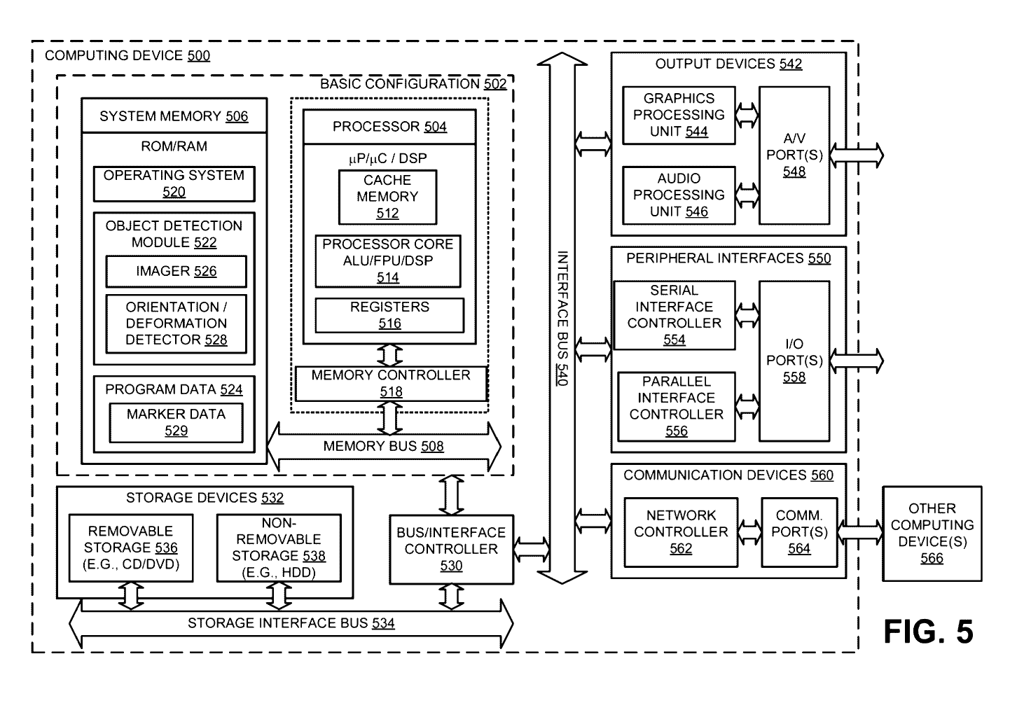

FIG. 5 illustrates a general purpose computing device, which may be used to determine object orientation and/or deformation, arranged in accordance with at least some embodiments described herein.

For example, the computing device 500 may be used to use orientation markers to determine object orientation and/or deformation as described herein. In an example basic configuration 502, the computing device 500 may include one or more processors 504 and a system memory 506. A memory bus 508 may be used to communicate between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, an object detection module 522, and program data 524. The object detection module 522 may include an imager 526 and an orientation/deformation detector 528 to implement orientation marker detection and object orientation/deformation detection as described herein. The program data 524 may include, among other data, orientation marker data. 529 to be used in determination of orientation and/or deformation of objects, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state chives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 550, and one or more communication devices 560) to the basic configuration 502 via the bus/interface controller 540. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device may include a network controller 562, which may be arranged to facilitate communications with one or more other computing devices 566 over a network communication link via one or more communication ports 564. The one or more other computing devices 566 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

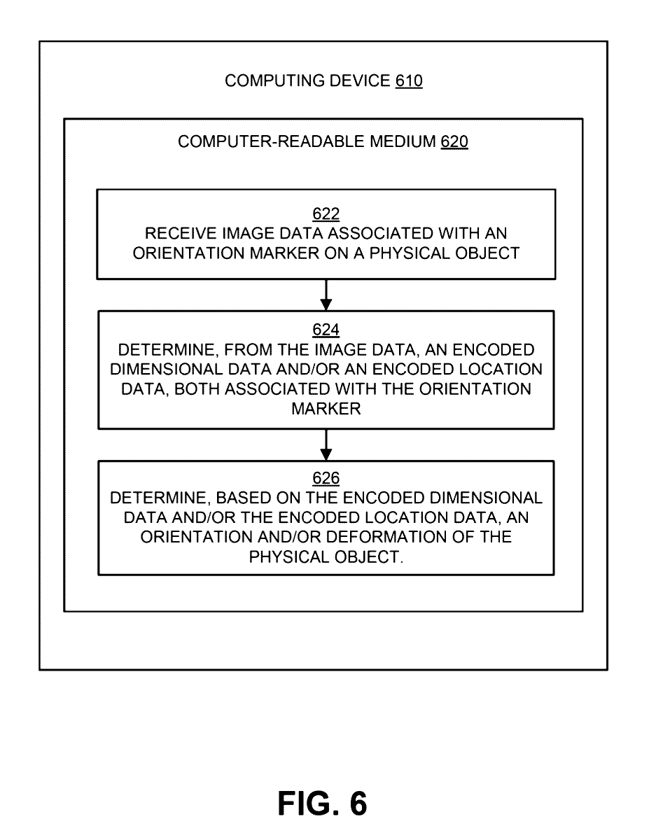

FIG. 6 is a flow diagram illustrating an example method to determine object orientation and/or deformation that may be performed by a computing device such as the computing, device in FIG. 5, arranged in accordance with at least some embodiments described herein.

Example methods may include one or more operations, functions or actions as illustrated by one or more of blocks 622, 624, and/or 626, and may in some embodiments be performed by a computing device such as the computing device 600 in FIG. 6. The operations described in the blocks 622-626 may also be stored as computer-executable instructions in a computer-readable medium such as a computer-readable medium 620 of a computing device 610.

An example process to determine object orientation and/or deformation may begin with block 622, “RECEIVE IMAGE DATA ASSOCIATED WITH AN ORIENTATION MARKER ON A PHYSICAL OBJECT”, where an orientation system (for example, the orientation/deformation detector 132) may receive image data of an orientation marker on a physical object, such as the orientation marker 104 on the object 102. In some embodiments, one or more imagers (for example, the imagers 120) may record image or video data and send the data to an image processor (for example, the image processor 130), which in turn may process the data and send the processed data to the orientation system.

Block 622 may be followed by block 624, “DETERMINE, FROM THE IMAGE DATA, AN ENCODED DIMENSIONAL DATA AND/OR AN ENCODED LOCATION DATA, BOTH ASSOCIATED WITH THE ORIENTATION MARKER”, where the orientation system may use the image data associated with the orientation marker to determine an encoded dimensional data and/or an encoded location data, as described above. For example, the encoded dimensional data may include a dimension and/or a size of the marker, and the encoded location data may include a location of the marker and/or one or more distances between the marker and other orientation markers on the object. In some embodiments, the orientation system may extract a code from the image data and use the code to reference an external entity such as a database, which in turn may store the relevant dimensional and/or location data.

Block 624 may be followed by block 626, “DETERMINE, BASED ON THE ENCODED DIMENSIONAL DATA AND/OR THE ENCODED LOCATION DATA, AN ORIENTATION AND/OR DEFORMATION OF THE PHYSICAL OBJECT”, where the orientation system may determine the orientation and/or deformation of the physical object based on the data determined in block 624. For example, the orientation system may compare the data encoded by the orientation marker to actual data extracted from the image data to determine how the object is oriented and/or whether the object is deformed. In some embodiments, the orientation system may calculate a distance change parameter based on distance(s) encoded in the orientation marker and actual distances observed in the image data to determine whether the object is deformed, as described above.

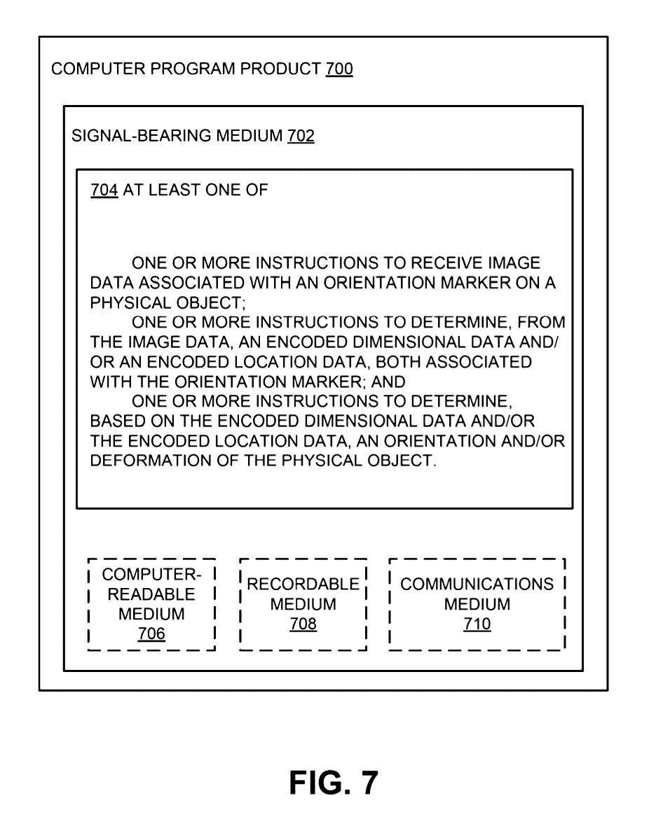

FIG. 7 illustrates a block diagram of an example computer program product, arranged in accordance with at least some embodiments described herein.

In some examples, as shown in FIG. 7, a computer program product 700 may include a signal bearing medium 702 that may also include one or more machine readable instructions 704 that, when executed by, for example, a processor may provide the functionality described herein. Thus, for example, referring; to the processor 504 in FIG. 5, the object detection module 522 may undertake one or more of the tasks shown in FIG. 7 in response to the instructions 704 conveyed to the processor 504 by the medium 702 to perform actions associated with detecting, object orientation and/or deformation as described herein. Some of those instructions may include, for example, instructions to receive image data associated with an orientation marker on a physical object, determine an encoded dimensional data and/or an encoded location data, both associated with the orientation marker, from the image data, and/or determine an orientation and/or deformation of the physical object based on the encoded dimensional data and/or the encoded location data, according to some embodiments described herein.

In some implementations, the signal bearing media 702 depicted in FIG. 7 may encompass computer-readable media 706, such as, but not limited to, a hard disk drive, a solid state drive, a compact disc (CD), a digital versatile disk (DVD), a digital tape, memory, etc. In some implementations, the signal bearing media 702 may encompass recordable media 707, such as, but not limited to, memory, read/write (R/W) CDs, R/W DVDs, etc. In some implementations, the signal bearing Media 702 may encompass communications media 710, such as, but not limited to, a digital and/or an analog communication medium (e.g., a fiber optic cable, a waveguide, a wired communications link, a wireless communication link, etc.). Thus, for example, the program product 700 may be conveyed to one or more modules of the processor 504 by an RF signal bearing medium, where the signal bearing media 702 is conveyed by the wireless communications media 710 (e.g., a wireless communications medium conforming with the IEEE 802.11 standard).

According to some examples, an orientation marker is provided to allow detection of object orientation and deformation. The orientation marker may include an alignment structure, an alignment marker portion, and a location marker portion. The alignment marker portion may be configured to encode at least one dimensional data associated with the alignment structure. The location marker portion may be configured to encode at least one location data associated with the orientation marker.

According to some embodiments, the at least one dimensional data may include a dimension parameter and/or a site parameter, where both parameters may be associated with the alignment structure. The at least one location data may include a distance to one or more other orientation markers on the physical object. In some embodiments, the at least one location data may include a sum of multiple distances, each of the distances from the orientation marker to a respective one of multiple orientation markers on the physical object.

According to other embodiments, the at least one location data may include a location of the orientation marker on the physical object arid/or at least one other location associated with one or more other orientation marker on the physical object. The location data may be relative to the orientation marker or absolute with respect to a fixed origin. In some embodiments, the alignment marker portion and/or the location marker portion may encode data as a database reference and/or as a two-dimensional barcode. The alignment structure, the alignment marker portion, and/or the location marker portion may be imprinted, printed, embossed, and/or painted on the physical object during manufacture of the physical object.

According to other examples, a method is provided to determine orientation information for a physical object. The method may include receiving image data associated with an orientation marker on the physical object and determining, from the image data, an encoded dimensional data and/or an encoded location data, both associated with the orientation marker. The method may further include determining an orientation of the physical object based on the encoded dimensional data and/or the encoded location data.

According to some embodiments, the encoded dimensional data may include an encoded dimension parameter and/or an encoded size parameter, both associated with the orientation marker. The method may further include determining an actual dimension and an actual size from the image data and determining a deformation of the physical object based on a comparison between the actual dimension and the encoded dimension parameter and/or a comparison between the actual size and the encoded size parameter.

According to other embodiments, the encoded location data may include an encoded location of at least one other orientation marker on the physical object and/or an encoded distance from the orientation marker to the at least one other orientation marker. The method may further include determining, from the image data., an actual location of the at least one other orientation marker and/or an actual distance from the orientation marker to the at least one other orientation marker. The method may further include determining a deformation of the physical object based on a comparison between the encoded location and the actual location and/or a comparison between the encoded distance and the actual distance.

According, to further embodiments, the encoded location data may include an encoded sum of distances from the orientation marker to multiple other orientation markers on the physical object. The method may further include determining, from the image data, an actual sum of distances from the orientation marker to the multiple other orientation markers and determining a deformation of the physical object based on a comparison between the encoded sum of distances and the actual sum of distances. In some embodiments, determining the encoded dimensional data and/or the encoded location data includes recovering a code from the image data and performing a database lookup using the recovered code to retrieve the encoded dimensional data and/or the encoded location data.

According to further examples, a system is provided to determine orientation information for a physical object. The system may include an imager and a processor block. The imager may be configured to receive image data associated with an orientation marker on the physical object. The processor block may be configured to determine, from the image data, an encoded dimensional data and/or an encoded location data, both associated with the orientation marker. The processor block may be further configured to determine an orientation of the physical object based on the encoded dimensional data and/or the encoded location data.

According to some embodiments, the encoded dimensional data may include an encoded dimension parameter and/or an encoded size parameter, both associated with the orientation marker. In some embodiments, the processor block may be configured to determine, from the image data, an actual dimension and an actual size. The processor block may be further configured to determine a deformation of the physical object and/or a distance from the imager to the orientation marker based on a comparison between the actual dimension and the encoded dimension parameter and/or a comparison between the actual size and the encoded size parameter.

According to other embodiments, the encoded location data may include an encoded location of at least one other orientation marker on the physical object and/or an encoded distance from the orientation marker to the at least one other orientation marker. In some embodiments, processor block may be configured to determine, from the image data, an actual location of the at least one other orientation marker and/or an actual distance from the orientation marker to the at least one other orientation marker. The processor block may be further configured to determine a deformation of the physical object based on a comparison between the encoded location and the actual location and/or a comparison between the encoded distance and the actual distance.

According to further embodiments, the encoded location data may include an encoded sum of distances from the orientation marker to multiple other orientation markers on the physical object. In some embodiments, the processor block may be configured to determine, from the image data, an actual sum of distances from the orientation marker to the multiple other orientation markers. The processor block may be further configured to determine a deformation of the physical object based on a comparison between the encoded sum of distances and the actual sum of distances. In some embodiments, the processor block may be further configured to recover a code from the image data and perform a database lookup using the recovered code to retrieve the encoded dimensional data and/or the encoded location data. The processor block may be further configured to use optical character recognition to determine the encoded dimensional data and/or the encoded location data.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e,g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing, on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a compact disc (CD), a digital versatile disk (DVD), a digital tape, a computer memory, a solid state drive, etc.; and a transmission type medium such as a digital and/or an analog communication medium e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically nteractable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third. etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An orientation marker for a physical object, the orientation marker comprising:
an alignment structure:
an alignment marker portion configured to encode at least one dimensional data associated with the alignment structure; and
a location marker portion configured to encode at least one location data associated with the orientation marker.

2. The orientation marker of claim 1, wherein the at least one dimensional data includes at least one of a dimension parameter and a size parameter, the dimension parameter and the size parameter associated with the alignment structure.

3. The orientation marker of claim 1, wherein the at least one location data includes a distance to at least one other orientation marker on the physical object.

4. The orientation marker of claim 3, wherein the at least one location data includes a sum of a plurality of distances, each of the distances from the orientation marker to a respective one of a plurality of orientation markers on the physical object.

5. The orientation marker of claim 1, wherein the at least one location data includes a location of the orientation marker on the physical object.

6. The orientation marker of claim 5, wherein the at least one location data further includes at least one other location associated with at least one other orientation marker on the physical object.

7. The orientation marker of claim 1, wherein the at least one location data is relative to the orientation marker or absolute with respect to a fixed origin.

8. The orientation marker of claim 1, wherein at least one of the alignment marker portion and the location marker portion encodes data as a database reference,

9. The orientation marker of claim 1, wherein at least one of the alignment marker portion and the location marker portion encodes data as a two-dimensional barcode.

10. The orientation marker of claim 1, wherein at least one of the alignment structure, the alignment marker portion, and the location marker portion are at least one of imprinted, printed, embossed, and painted on the physical object during manufacture of the physical object

11. A method to determine orientation information for a physical object, the method comprising:
receiving image data associated with an orientation marker on the physical object;
determining, from the image data, at least one of an encoded dimensional data and an encoded location data, both associated with the orientation marker; and
determining, based on at least one of the encoded dimensional data and the encoded location data, an orientation of the physical object.

12. The method of claim 11, wherein the encoded dimensional data includes at least one of an encoded dimension parameter and an encoded size parameter, both associated with the orientation marker, and the method further comprises:
determining, from the image data, an actual dimension and an actual size; and
determining, a deformation of the physical object based on at least one of a comparison between the actual dimension and the encoded dimension parameter and a comparison between the actual size and the encoded size parameter.

13. The method of claim 11, wherein the encoded location data includes at least one of an encoded location of at least one other orientation marker on the physical object and an encoded distance from the orientation marker to the at least one other orientation marker, and the method further comprises:
determining, from the image data, at least one of an actual location of the at least one other orientation marker and an actual distance from the orientation marker to the at, least one other orientation marker; and
determining a deformation of the physical object based on at least one of a comparison between the encoded location and the actual location and a comparison between the encoded distance and the actual distance.

14. The method of claim 11, wherein the encoded location data includes an encoded sum of distances from the orientation marker to a plurality of other orientation markers on the physical object, and the method further comprises:
determining, from the image data, an actual sum of distances from the orientation marker to the plurality of other orientation markers; and
determining a deformation of the physical object based on a comparison between the encoded sum of distances and the actual sum of distances.

15. The method of claim 11, wherein determining the at least one of the encoded dimensional data and the encoded location data comprises:
recovering a code from the image data; and
performing a database lookup using the recovered code to retrieve the at least one of the encoded dimensional data and the encoded location data.

16. A system to determine orientation information for a physical object, the system comprising:
an imager configured to receive image data associated with an orientation marker on the physical object; and
a processor block configured to:
determine, from the image data, at least one of an encoded dimensional data and an encoded location data, both associated with the orientation marker; and
determine, based on at least one of the encoded dimensional data and the encoded location data, an orientation of the physical object.

17. The system of claim 16, wherein the encoded dimensional data includes at least one of an encoded dimension parameter and an encoded size parameter, both associated with the orientation marker, and the processor block is further configured to:
determine, from the image data, an actual dimension and an actual size; and
determine, based on at least one of a comparison between the actual dimension and the encoded dimension parameter and a comparison between the actual size and the encoded size parameter, at least one of:
a deformation of the physical object; and
a distance from the imager to the orientation marker.

18. The system of claim 16, wherein the encoded location data includes at least one of an encoded location of at least one other orientation marker on the physical object and an encoded distance from the orientation marker to the at least one other orientation marker, and the processor block is further configured to:
determine, from the image data, at least one of an actual location of the at least one other orientation marker and an actual distance from the orientation marker to the at least one other orientation marker; and
determine a deformation of the physical object based on at least one of a comparison between the encoded location and the actual location and a comparison between the encoded distance and the actual distance.

19. The system of claim 16, wherein the encoded location data includes an encoded sum of distances from the orientation marker to a plurality of other orientation markers on the physical object, and the processor block is further configured to:
determine, from the image data, an actual sum of distances from the orientation marker to the plurality of other orientation markers; and
determine a deformation of the physical object based on a comparison between the encoded sum of distances and the actual sum of distances.

20. The system of claim 16, wherein the processor block is further configured to:
recover a code from the image data; and
perform a database lookup using the recovered code to retrieve the at least one of the encoded dimensional data and the encoded location data.

21. The system of claim 16, wherein the processor block is further configured to use optical character recognition to determine the at least one of the encoded dimensional data and the encoded location data.
